(19) United States
(12) Patent Application Publication
(10) Pub. No.: US 2016/0338543 A1
(43) Pub. Date: Nov. 24, 2016

(54) CHEESE GRATING SYSTEM

(71) Applicants: John D'Angelo, Seaford, NY (US); Francesca D'Angelo, Seaford, NY (US)

(72) Inventors: John D'Angelo, Seaford, NY (US); Francesca D'Angelo, Seaford, NY (US)

(21) Appl. No.: 14/718,302

(22) Filed: May 21, 2015

(51) Int. Cl. A47J 43/25

(52) U.S. Cl. CPC A47J 43/25

(57) ABSTRACT

A system for cheese grating that includes: a container, where the container holds grated cheese; a top-grating surface on the container; and a slotted bottom opening within the container. The container may be designed in various shapes and sizes. The system may further include a lever on the container to actuate the slotted bottom opening. Further, the present invention includes a method of grating cheese including the steps of: applying cheese across a top grating surface; accumulating grated cheese in a container below the top grating surface; and dispensing the grated cheese through a slotted opening on a bottom surface of the container. The step of dispensing may preferably include actuating a lever on the container.

### BACKGROUND OF THE INVENTION

1. Field of Invention

The present invention relates to a cheese grater that includes a grating top surface, an enclosed container and an opening for the dispensing of the grated cheese.

2. Description of Related Art

Grated cheese is a common food ingredient that is used as a typical topping on top of pasta and pizza. Many times it is advantageous to avoid grating the cheese prior to use. If cheese is grated in advance many times the cheese fuses together when left in a stationary position. Further grating cheese over a hot surface or hot stove can be quite difficult and messy task requiring an extensive cleanup. Many times the grating of the cheese takes place after the food is removed from the cooking surface. However it is most effective to grate the cheese over the food while still on the cooking surface so that the cheese provides a layer that is somewhat melted and adheres to the surface of the food. As a consequence, it would be advantageous to have an effective device that could effectively grate cheese for a use over a stove or another hot surface.

### SUMMARY OF THE INVENTION

The present invention relates to a system for cheese grating that includes: a container, where the container holds grated cheese; a top-grating surface on the container; and a slotted bottom opening within the container. The container may be designed in various shapes and sizes. The system may further include a lever on the container to actuate the slotted bottom opening. Further, the present invention includes a method of grating cheese including the steps of: applying cheese across a top grating surface; accumulating grated cheese in a container below the top grating surface; and dispensing the grated cheese through a slotted opening on a bottom surface of the container. The step of dispensing may preferably include actuating a lever on the container.

### BRIEF DESCRIPTION OF DRAWINGS

FIG. 1 depicts a top surface view of each respective cheese grater in accordance with the present invention.

FIG. 2 depicts side views of each respective cheese grater in accordance with the present invention.

FIG. 3 depicts a bottom view of each respective cheese grater in accordance with the present invention.

### DETAILED DESCRIPTION

The present invention relates to a cheese grating system that includes three various embodiments of a cheese grater. Each embodiment is unique in its shape and volume of cheese that could be grated and maintained within the container for use. The cheese graters in accordance with the present invention each have a top-grating surface that is used to grate the cheese applied to the surface. A container lies beneath the top-grating surface that receives the grated cheese for the release of the cheese through a bottom surface. The bottom surface includes an opening and a lever that rotates slots within the opening to allow for the dispensing of grated cheese.

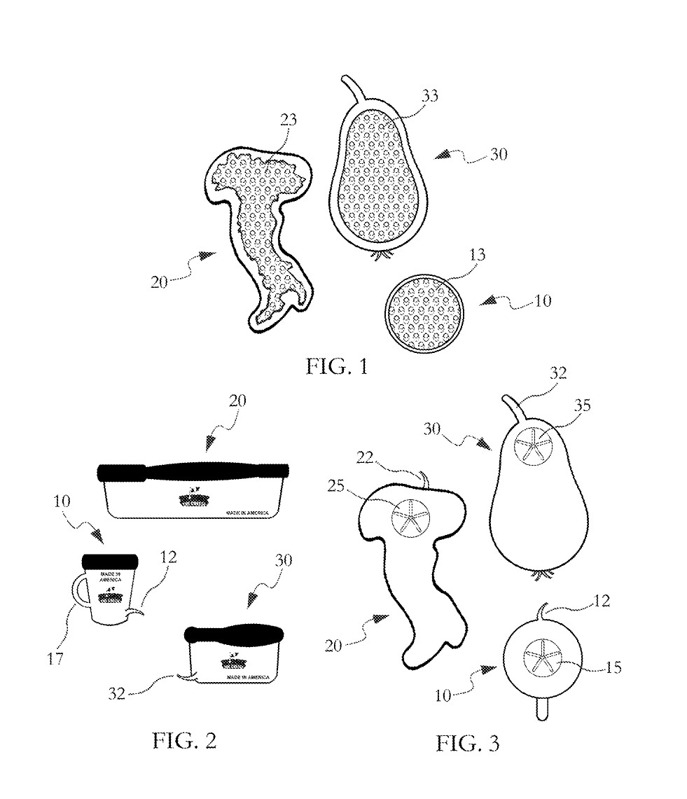

In reference to FIG. 1, top views of cheese graters 10, 20 and 30 are depicted. Each cheese grater has a top-grating surface 13, 23 and 33 respectively. Cheese may be moved over this top-grating surface of the cheese graters 10, 20 and 30 and creates the grated cheese within the containers shown at a side view in FIG. 2. The grater 10 includes a handle 17 and a lever 12 that is used to maneuver an opening on the underside of the grater. This side view is also available for graters 20 and 30 and a lever 32 is shown on grater 30.

FIG. 3 depicts a bottom view of each respective grater. Each respective grater of 10, 20 and 30 includes an opening or a slotted opening 15, 25, 35. The slotted opening 15, 25, 35 allows for the dispensing of grated cheese in each respective grater. Lever 32 shown on grater 30, lever 12 shown on grater 10 and lever 22 shown on grater 20 enable the movement of each respective dispensing opening of each grater. During use, a user moves the lever provided on each grater to dispense grated cheese through the bottom surface of each respective grater. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for cheese grating comprising:
a. a container, where the container holds grated cheese;
b. a top grating surface on the container; and
c. a slotted bottom opening within the container.

2. The system for cheese grating according to claim 1, further including a lever to actuate the slotted bottom opening.

3. A method of grating cheese comprising the steps of:
a. applying across a top grating surface;
b. accumulating grated cheese in a container below the top grating surface; and
c. dispensing the grated cheese through a slotted opening on a bottom surface of the container.

4. The method according to claim 3, where the step of dispensing includes actuating a lever on the container.
